(19) United States
(12) Patent Application Publication
(10) Pub. No.: US 2007/0254642 A1
(43) Pub. Date: Nov. 1, 2007

(54) Apparatus and Method Providing Rapid Talk Burst Control for Push to Talk Over Cellular (Poc) Communications

(76) Inventor: Janne Suotula, Espoo (FI)

Correspondence Address: ERICSSON INC., 6300 LEGACY DRIVE, M/S EVR 1-C-11, PLANO, TX, 75024, US

(21) Appl. No.: 11/575,418

(22) PCT Filed: Sep. 21, 2004
(86) PCT No.: PCT/IB04/03074

§ 371 Date: Jul. 13, 2007

(51) Int. Cl. H04Q 7/28; H04M 1/00

(52) U.S. Cl. 455/422.1; 455/550.1

(57) ABSTRACT

An apparatus and method for providing rapid Talk Burst Control (TBC) for a Push To Talk over Cellular (PoC) Client engaged in a PoC communication with another PoC Client through a PoC Server (33). When a first PoC Client (31) completes a talk burst, the PoC Server (33) consults a communication pattern model (86) to predict which PoC Client is the predicted next talker. The PoC Server then sends a TB Pre-granted message (41) to the predicted next talker (32), pre-granting’, permission to talk before the predicted next talker requests permission to talk. When the predicted next talker presses the push to talk (PTT) button on his Client handset, he immediately has the right to talk without any further signaling with the PoC Server. If an unpradicted user requests permission to talk, the pre-granted permission is revoked, and the unpredicted user is granted permission.

### TECHNICAL FIELD OF THE INVENTION

The present invention relates generally to communication networks, and in particular, to an apparatus and method providing rapid Talk Burst Control (TBC) for Push To Talk over Cellular (PoC) communications.

### DESCRIPTION OF RELATED ART

Push To Talk over Cellular (PoC) is a fast-connect, half-duplex service of the type generally known as Push-to-Talk (PTT) or voice chat services. PTT applications provide wireless users with a virtually instantaneous method of connecting to other users, with just the touch of a button on their handset. The service is half-duplex and can be used for one-to-one private calls as well as one-to-many group calls. Users can take advantage of private, direct, simultaneous radio voice connection over very wide areas, affordably and conveniently, often replacing other devices such as pagers and two-way radios. Users receiving the call hear the caller's voice automatically without having to answer the call.

PoC is the official name used in the open specifications currently being developed by the Open Mobile Alliance (OMA) for this service. The PoC specifications utilize a number of existing specifications from the Internet Engineering Task Force (IETF), the Third Generation Partnership Project (3GPP), and 3GPP2 including the capabilities of the 3GPP IP Multimedia Subsystem (IMS) and the 3GPP2 Multimedia Domain (MMD) to enable IP connectivity between mobile devices. In one solution, PoC uses a server, which is independent of the existing radio and core networks. PoC may be implemented on the IP backbone over radio technologies such as WCDMA, CDMA2000, GPRS, UMTS, and 802.11.

The use of IMS and MMD adds the ability to integrate voice and data services over IP-based packet-switched networks. Two fundamental capabilities are added on top of the packet-switched domain. First is the ability to find a user via the Session Initiation Protocol (SIP) to initiate a session. Second is the ability to integrate new services such as PTT. By introducing IMS and its multiple service-delivery capability, a common infrastructure for services is established, and the requirement to build a service delivery infrastructure for each service is eliminated.

The voice stream in PoC is controlled by a Talk Burst Control (TBC) mechanism. When a PoC User wants to talk, the User presses the Push-To-Talk (PTT) button on his/her PoC Client handset, and a TBC protocol message exchange occurs between the PoC Client and a PoC Server implemented in the IMS/MMD network. The TBC protocol exchange either grants or denies the PoC User's request to talk. This TBC protocol exchange must be fast in order to guarantee a good user experience and make PoC a true “instant” talk application.

FIG. 1 is a signaling diagram illustrating the flow of signaling messages when utilizing the existing TBC protocol. A PoC Client A 11 is talking to a PoC Client B 12 under the control of a PoC Server 13. Each PoC Client must request permission to talk from the PoC server. FIG. 1 illustrates the usual condition for a person-to-person call in which the two PoC Clients alternate talking. The notation PTT indicates the point in time that one of the PoC Clients pushes the PTT button on the Client's handset, and the notation RTS indicates the point in time that the Client receives the right to speak. The notation StS thus indicates the delay time experienced by the User from the time the PTT button is pressed until the right to speak is received.

Initially, PoC Client A 11 presses the PTT button on his handset, and a TB Request message 14 is sent to the PoC Server 13 requesting permission to talk. The PoC Server returns a TB Granted message 15 to PoC Client A. The PoC Server also sends a TB Taken message 16 to PoC Client B 12 notifying PoC Client B that PoC Client A has been granted the right to speak. Thereafter, the radio bearer between the Clients is activated, and the voice stream 17 is carried from PoC Client A to PoC Client B as long as PoC Client A holds down the PTT button. When PoC Client A releases the PTT button, a TB Release message 18 is sent to the PoC Server. The radio bearer then returns to an idle mode, and the PoC Server sends TB Idle indications 19, 20 to PoC Client A and PoC Client B, respectively, since no one is sending media.

In steps 21-27, the process is then performed in reverse when PoC Client B requests and receives permission to speak. Finally steps 14-20 are repeated as PoC Client A again requests and receives permission to speak.

The StS delay may be rather lengthy in today's radio access networks. The exchange of TBC protocol messages will, in some cases, trigger the radio bearer to go from a dormant state to an active state, and this may take additional time. The total length of time between pressing the PTT button and receiving the right to speak may vary depending on the type of radio access network, but it may take up to several seconds. This StS length will not be acceptable to many users.

Accordingly, there is a need for an improved apparatus and method for providing rapid Talk Burst Control (TBC) for PoC communications.

### SUMMARY OF THE INVENTION

The present invention provides an optimized TBC mechanism for reducing the response time between the time that a PoC User presses the PTT button until the User gets an indication that the talk request has been granted.

Thus in one aspect, the present invention is directed to a method of providing rapid Talk Burst Control for a PoC Client engaged in a PoC communication, wherein PoC Client A is engaged in a PoC communication with PoC Client B. The method includes the steps of detecting the completion of a talk burst by PoC Client A; and pre-granting PoC Client B permission to talk prior to receiving a request to talk from PoC Client B. The pre-granting step may be performed by sending a TBC protocol message to PoC Client B pre-granting the right to transmit media. The method may utilize a communication pattern model to predict that PoC Client B is the predicted next talker. In a further embodiment, PoC Client A and PoC Client B are engaged in a group communication, and PoC Client B is a prioritized user. In this embodiment, the method may pre-grant PoC Client B permission to talk after each talk burst, regardless of who transmitted the previous talk burst.

In another aspect, the present invention is directed to an apparatus for providing rapid Talk Burst Control for a PoC Client engaged in a PoC communication, wherein PoC Client A is engaged in a PoC communication with PoC Client B. The apparatus includes means for detecting the completion of a talk burst by PoC Client A; and means for pre-granting PoC Client B permission to talk prior to receiving a request to talk from PoC Client B. The apparatus may also include a communication pattern model that predicts that PoC Client B is the predicted next talker. The apparatus may be implemented in a PoC Server.

In yet another aspect, the present invention is directed to a PoC Client handset enabling a user to communicate with at least one other user through a PoC Server. The PoC Client handset includes a push-to-talk (PTT) button for signaling to the PoC Server, when the PTT button is pressed, that a user requests permission to talk, and for signaling to the PoC Server, when the PTT button is released, that the user has finished talking. The PoC Client handset also includes means for receiving from the PoC server, an indication that the user has been pre-granted permission to talk prior to the user pressing the PTT button. In further embodiments, the handset may also include means responsive to the indication that the user has been pre-granted permission to talk, for indicating to the user that the user has been pre-granted permission to talk, and for indicating to the user that the user has the right to talk immediately after the user presses the PTT button.

### BRIEF DESCRIPTION OF THE DRAWINGS

FIG. 1 (Prior Art) is a signaling diagram illustrating the flow of signaling messages when utilizing the existing TBC protocol;

FIG. 2 is a signaling diagram illustrating the flow of signaling messages in a first exemplary embodiment of the present invention;

FIG. 3 is a signaling diagram illustrating the flow of signaling messages in a second exemplary embodiment of the present invention;

FIG. 4 is a signaling diagram illustrating the flow of signaling messages in a third exemplary embodiment of the present invention;

FIG. 5 is a signaling diagram illustrating the flow of signaling messages in a fourth exemplary embodiment of the present invention; and

FIG. 6 is a simplified block diagram of a PoC Server modified in accordance with the apparatus of the present invention.

### DETAILED DESCRIPTION OF EMBODIMENTS

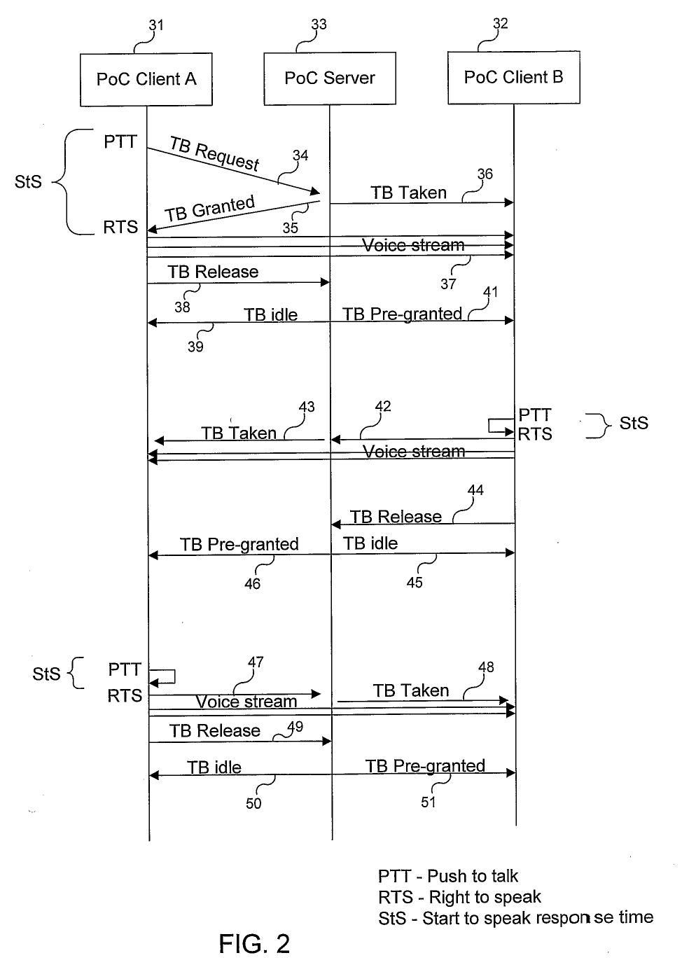

FIG. 2 is a signaling diagram illustrating the flow of signaling messages in a first exemplary embodiment of the present invention. PoC Client A 31 and PoC Client B 32 are engaged in a person-to-person call under the control of a PoC Server 33. Person-to-person calls usually follow a communication pattern in which a first PoC User talks and then the other PoC user responds. Thus, each PoC Client transmits every second talk burst. In the example shown in FIG. 2, the users alternate, their speech, with PoC Client A talking first, PoC Client B talking next, and then PoC Client A talking again, and so on. This embodiment takes this alternative speech pattern into account by accessing a communication pattern model or algorithm in the TBC mechanism in order to provide faster response time to the next talker.

To improve the latency time for the predicted next talker, the invention provides the predicted next talker with a pre-granted permission to talk. The pre-granted permission to talk may be signaled from the PoC Server to the PoC Client using a new TBC protocol message during the idle-state when no voice is exchanged in the PoC session, but the PoC session is ongoing. Thus, the PoC Client receiving media is always pre-granted permission to talk after the previous talk burst has ended (i.e., after the TB Release message is received in the PoC Server). The PoC Client handset may then indicate to the user that he has been given pre-granted permission to talk. When the PoC Client having the pre-granted permission to talk presses the PTT button, he is immediately given permission to talk without any additional signaling to the PoC Server. Thus the StS delay time is greatly reduced.

When the PoC Server receives media from the PoC Client having pre-granted permission to talk, the PoC Server sends a TB Taken message to the other PoC Client indicating that the pre-granted PoC Client now has permission to talk, and forwards the media to the other PoC Client.

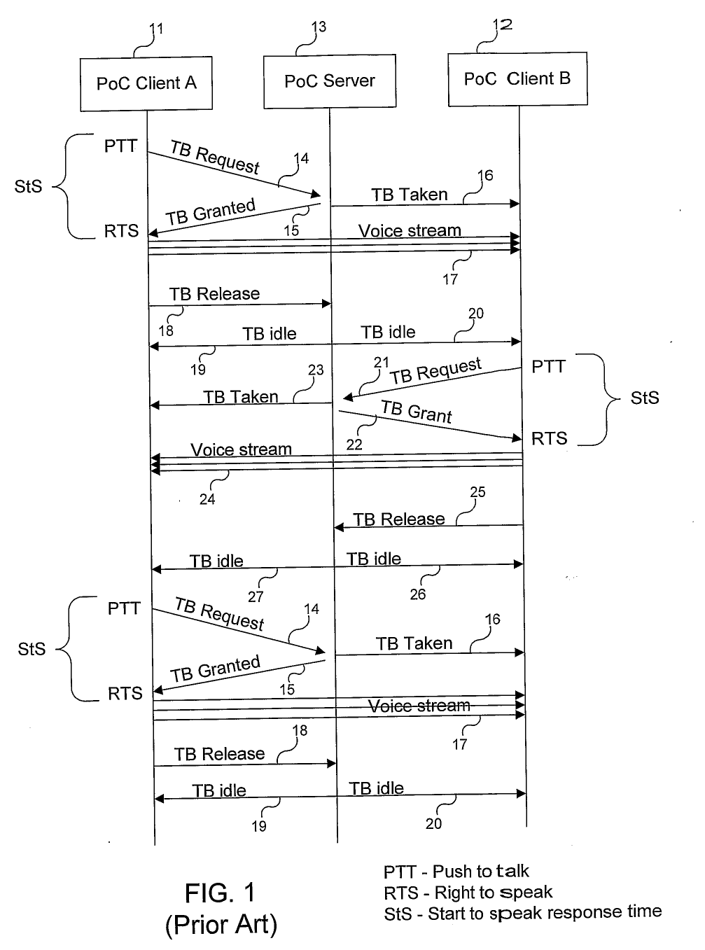

The example illustrated in FIG. 2 shows that an initial talk request from PoC Client A 31 may follow steps 34-38, which are essentially the same as steps 14-18 of FIG. 1. Following the TB Release message 18, however, instead of sending a TB Idle indication to each PoC Client, the PoC Server 33 sends a TB Idle indication 39 to PoC Client A 31 and a TB Pre-granted message 41 to PoC Client B 32. PoC Client B now has pre-granted permission to talk. Thereafter, when PoC Client B presses the PTT button, User B immediately receives an RTS indication and can immediately begin talking. When the voice stream 42 is received by the PoC Server, the PoC Server sends a TB Taken message 43 to PoC Client A indicating that PoC Client B now has permission to talk, and forwards the media to PoC Client A.

When PoC Client B 32 is finished talking and releases the PTT button, a TB Release message 44 is sent to the PoC Server 33. Based on the predicted alternating speech pattern, the PoC Server 33 sends a TB Idle indication 45 back to PoC Client B, and sends a TB Pre-granted message 46 to PoC Client A. PoC Client A now has pre-granted permission to talk. Thereafter, when PoC Client A presses the PTT button, User A immediately receives an RTS indication and can immediately begin talking. When the voice stream 47 is received by the PoC Server, the PoC Server sends a TB Taken message 48 to PoC Client B indicating that PoC Client A now has permission to talk, and forwards the media to PoC Client B.

When PoC Client A 31 is finished talking and releases the PTT button, a TB Release message 49 is sent to the PoC Server 33. Based on the predicted alternating speech pattern, the PoC Server 33 sends a TB Idle indication 50 back to PoC Client A, and sends a TB Pre-granted message 51 to PoC Client B. Thus the method continues to alternate providing pre-granted permission to talk to each of the PoC Clients.

It should be noted that in this scenario the voice stream itself has to trigger the radio access network to go from the dormant state to the active state (if needed). This delay will influence the turnaround time (TaT), which is defined as the time period between the point in time when a PoC User releases the PTT button and when the PoC User can hear the other PoC User begin to speak. However, a longer TaT is typically less annoying than a longer StS.

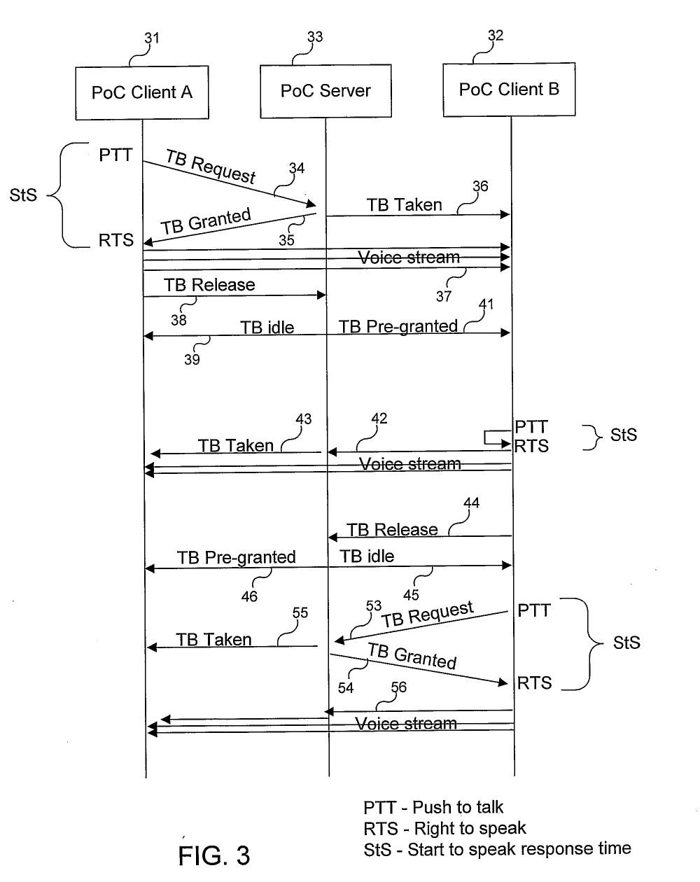

FIG. 3 is a signaling diagram illustrating the flow of signaling messages in a second exemplary embodiment of the present invention. In this embodiment, a PoC User engaged in a person-to-person call transmits two talk bursts in a row rather than alternating with the other PoC User. The example illustrated in FIG. 3 shows that an initial talk request from PoC Client A 31 may follow steps 34-37. Upon the transmission of the TB Release message 38, the PoC Server 33 sends a TB Idle indication 39 to PoC Client A and a TB Pre-granted message 41 to PoC Client B. Thereafter, when PoC Client B presses the PTT button, User B immediately receives an RTS indication and can immediately begin talking. When the voice stream 42 is received by the PoC Server, the PoC Server sends a TB Taken message 43 to PoC Client A indicating that PoC Client B now has permission to talk, and forwards the media to PoC Client A.

When PoC Client B 32 is finished talking and releases the PTT button, a TB Release message 44 is sent to the PoC Server 33. Based on the predicted alternating speech pattern, the PoC Server 33 sends a TB Idle indication 45 back to PoC Client B, and sends a TB Pre-granted message 46 to PoC Client A. PoC Client A now has pre-granted permission to talk. Thereafter, PoC Client B unexpectedly presses the PTT button and sends a TB Request message 53 to the PoC Server. In this embodiment, the PoC Server immediately sends a TB Granted message 54 to PoC Client B, granting permission to talk. The PoC Server also sends a TB Taken message 55 to PoC Client A, essentially rescinding the pre-granted permission to talk and informing PoC Client A that another PoC Client now has permission to talk. When the PoC Server receives the voice stream 56 from PoC Client B, the PoC Server forwards the voice stream to PoC Client A.

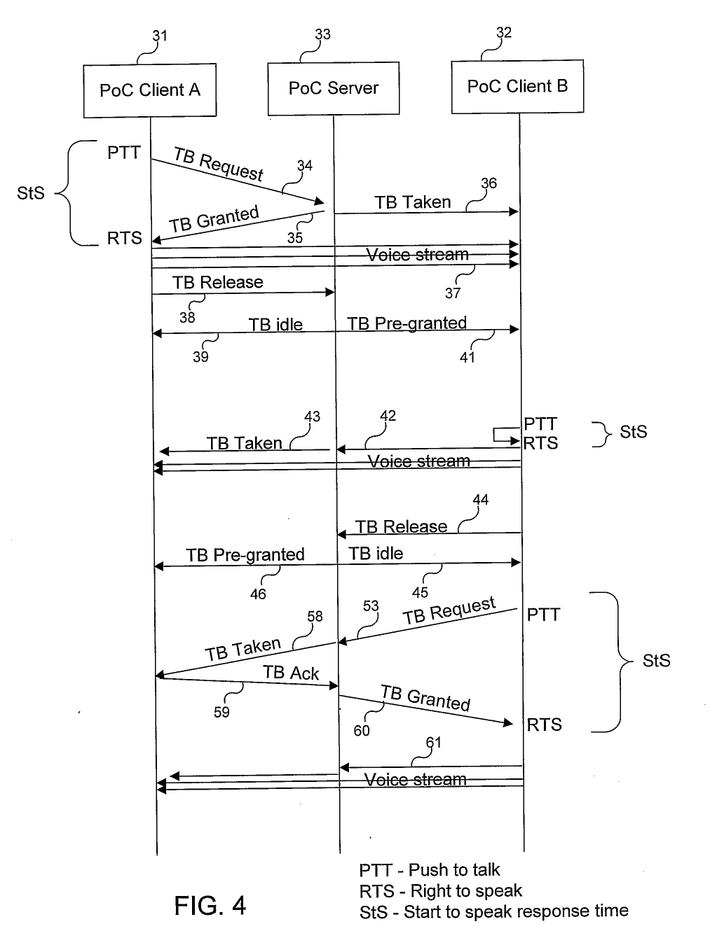

FIG. 4 is a signaling diagram illustrating the flow of signaling messages in a third exemplary embodiment of the present invention. In this embodiment, like FIG. 3, a PoC User engaged in a person-to-person call transmits two talk bursts in a row rather than alternating with the other PoC User. The steps of this embodiment are the same as FIG. 3 from step 34 through step 53 when PoC Client B unexpectedly presses the PTT button and sends a TB Request message 53 to the PoC Server. In this embodiment, the PoC Server first sends a TB Taken message 58 to PoC Client A, essentially revoking the pre-granted permission to talk and informing PoC Client A that another PoC Client now has permission to talk. The PoC Server then waits for PoC Client A to return a TB Acknowledgment message 59 before sending a TB Granted message 60 to PoC Client B, granting permission to talk. When the PoC Server receives the voice stream 61 from PoC Client B, the PoC Server forwards the voice stream to PoC Client A.

In another embodiment, the users may be engaged in a group communication. One of the users may be a prioritized PoC User, who may be a dispatcher or the group owner. The object of this embodiment is to optimize the StS delay of the prioritized PoC User. The solution provided by this embodiment is that the prioritized PoC User is always given pre-granted permission to talk upon the completion of a talk burst, regardless of whom was sending the completed talk burst.

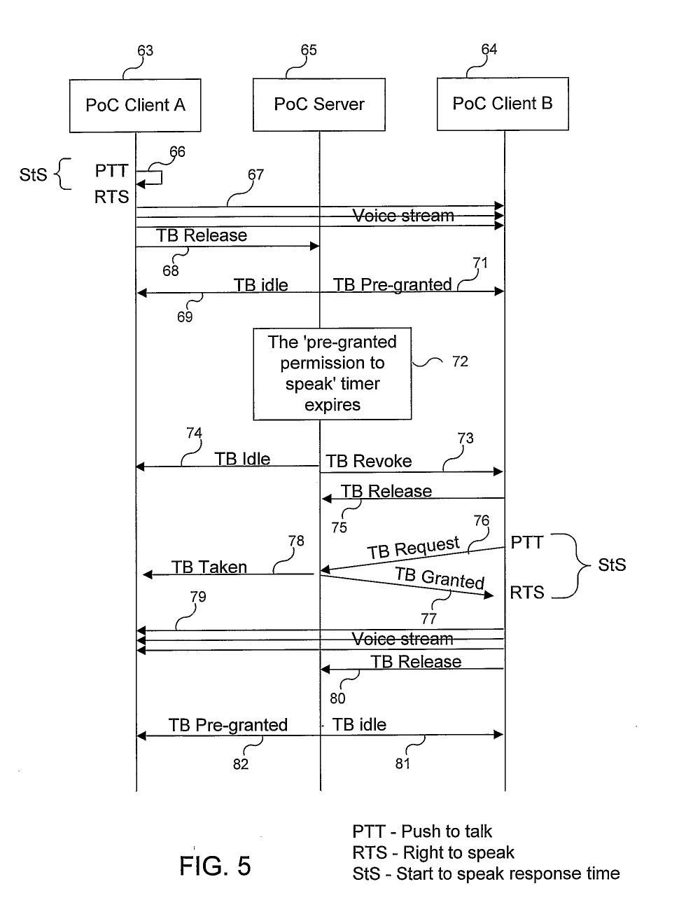

FIG. 5 is a signaling diagram illustrating the flow of signaling messages in a fourth exemplary embodiment of the present invention. In this embodiment, PoC Client A 63 and PoC Client B 64 are engaged in a person-to-person call under the control of a PoC Server 65. The example begins at step 66, where PoC Client A experiences a very short StS delay because he has been pre-granted permission to talk in previous steps not shown in FIG. 5, but shown for example, in FIGS. 2-4. The voice stream 67 is then transmitted to PoC Client B 64 until PoC Client A finishes talking and sends a TB Release message 68 to the PoC Server 33. The PoC Server then follows the person-to-person speech pattern model, which assumes that the PoC Clients will alternate speaking. Thus, a TB Idle message 69 is sent to PoC Client A, and a TB Pre-granted message 71 is sent to PoC Client B. Simultaneously, the PoC Server starts a Pre-granted Permission Timer, which expires at 72. The timer measures a maximum duration of the pre-granted permission to speak. The typical person-to-person speech pattern model first expects a reply on each talk burst, but if no reply is given after a certain time interval, there is equal probability that the next talk burst will come from PoC Client A or PoC Client B. Therefore, upon expiry of the timer, the PoC Server sends a TB Revoke message 73 to PoC Client B revoking the pre-granted permission to speak.

The PoC Server also sends another TB Idle message 74 to PoC Client A because PoC Client B must acknowledge the TB Revoke message before the PoC server can conclude that the pre-granted permission to speak is removed. In the illustrated embodiment, PoC Client B acknowledges the TB Revoke message with a TB Release message 75.

As illustrated, after the expiry of the timer and the revocation of the pre-granted permission to speak, PoC Client B 64 sends a TB Request message 76 requesting permission to speak. The PoC Server 33 returns a TB Granted message 77 to PoC Client B. The PoC Server also sends a TB Taken message 78 to PoC Client A 63 notifying PoC Client A that PoC Client B has been granted the right to speak. Thereafter, the radio bearer between the Clients is activated, and the voice stream 79 is carried from PoC Client B to PoC Client A. When PoC Client B releases the PTT button, a TB Release message 80 is sent to the PoC Server. The PoC Server then sends a TB Idle message 81 to PoC Client B, and sends a TB Pre-granted message 82 to PoC Client A.

In one embodiment, a TB Pre-granted indication is included in the TB Idle message. The PoC Server “pumps” TB Idle messages to all PoC Clients during the idle period so the TB Revoke message 73 sent to remove the pre-granted permission may be sent instead of a TB Idle message and thus not create extra traffic.

It should be noted that the reply (here the TB Release message 75) creates one extra message in the uplink. However, if TBC protocol messages are sent reliable (for example using TCP), the TB Release message may be removed.

It should also be noted that the Pre-granted Permission Timer may be utilized for both person-to-person calls as well as group communications and prioritized users. The timer may be utilized to revoke the pre-granted permission to talk whenever the user with the pre-granted permission waits too long to begin talking.

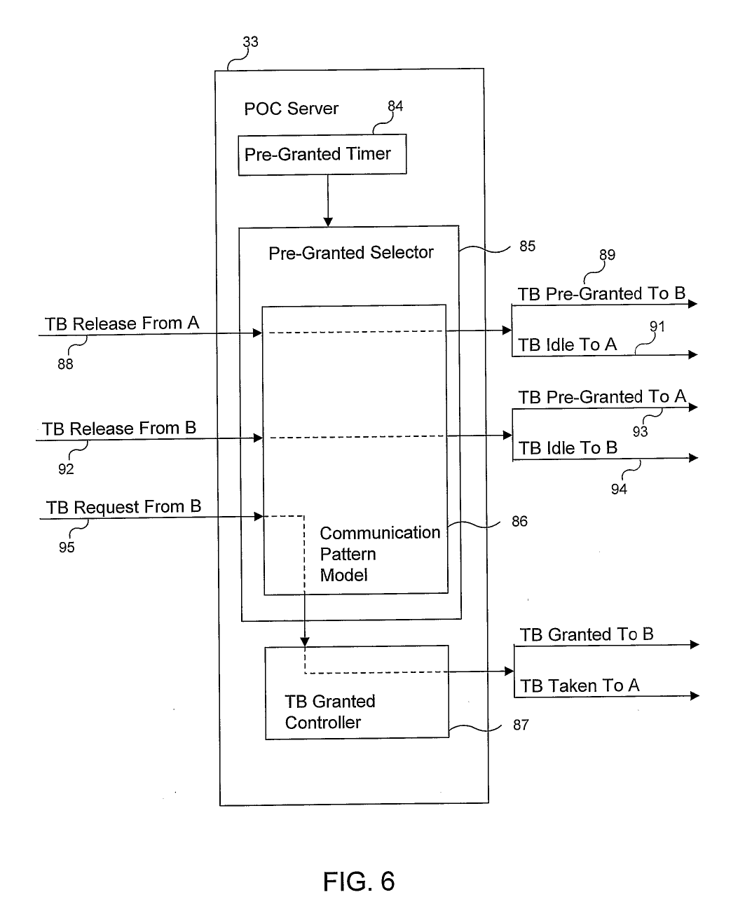

FIG. 6 is a simplified block diagram of a PoC Server 33 modified in accordance with the apparatus of the present invention. In addition to the normal means for communicating with Clients and forwarding media, the PoC Server includes a Pre-granted Permission Timer 84, a Pre-granted Selector 85 containing a Communication Pattern Model 86, and a TB Granted Controller 87.

When PoC Client A finishes talking, a TB Release Message 88 is sent to the PoC Server. The message is routed to the Pre-granted Selector 85, which uses the Communication Pattern Model 86 to issue a TB Pre-granted message 89 to PoC Client B and a TB Idle message 91 to PoC Client A. When PoC Client B finishes talking, a TB Release Message 92 is sent to the PoC Server. The message is routed to the Pre-granted Selector, which uses the Communication Pattern Model to issue a TB Pre-granted message 93 to PoC Client A and a TB Idle message 94 to PoC Client B. If PoC Client B then requests to speak out of turn, the PoC Server receives a TB Request message 95 from PoC Client B. This message is routed to the TB Granted Controller 87. The TB Granted Controller issues a TB Granted message 96 to PoC Client B and revokes the pre-granted permission given to PoC Client A by sending a TB Taken message to PoC Client A, as shown in the embodiments of FIGS. 3 and 4.

Those skilled in the art will readily appreciate that the present invention may be implemented using either hardware, or software, or both, and further, software implementations may vary using different languages and data structures. The present invention is not limited to a specific language and/or class of languages, nor is it limited to any single data structure implantation.

The present invention may of course, be carried out in other specific ways than those herein set forth without departing from the essential characteristics of the invention. The present embodiments are, therefore, to be considered in all respects as illustrative and not restrictive and all changes coming within the meaning and equivalency range of the appended claims are intended to be embraced therein.

1. A method of providing rapid Talk Burst Control (TBC) for a Push To Talk over Cellular (PoC) Client engaged in a PoC communication, wherein PoC Client A is engaged in a PoC communication with PoC Client B, said method comprising the steps of:
detecting the completion of a talk burst by PoC Client A; and
pre-granting PoC Client B permission to talk prior to receiving a request to talk from PoC Client B.

2. The method of claim 1, wherein the step of pre-granting PoC Client B permission to talk includes sending a TBC protocol message to PoC Client B pre-granting PoC Client B the right to transmit media.

3. The method of claim 1, further comprising, after detecting the completion of the talk burst by PoC Client A, the step of utilizing a communication pattern model to predict that PoC Client B is the predicted next talker.

4. The method of claim 3, wherein PoC Client A and PoC Client B are engaged in a person-to-person communication and the communication pattern model predicts that talk bursts will alternate between PoC Client A and PoC Client B after each talk burst.

5. The method of claim 1, wherein PoC Client A and PoC Client B are engaged in a group communication and PoC Client B owns the group, and the method includes pre-granting PoC Client B permission to talk after each talk burst regardless of who transmitted the previous talk burst.

6. The method of claim 1, wherein PoC Client A and PoC Client B are engaged in a group communication and PoC Client B is a prioritized user, and the method includes pre-granting PoC Client B permission to talk after each talk burst, regardless of who transmitted the previous talk burst.

7. The method of claim 1, further comprising the steps of: starting a timer when PoC Client B is pre-granted permission to talk: and revoking the permission to talk if PoC Client B does not initiate a talk burst before the timer expires.

8. The method of claim 1, further comprising, after pre-granting PoC Client B permission to talk, the steps of:
receiving a request to talk from PoC Client A;
immediately granting PoC Client A permission to talk; and
notifying PoC Client B that permission to talk has been revoked after granting PoC Client A permission to talk.

9. The method of claim 1, further comprising, after pre-granting PoC Client B permission to talk, the steps of:
receiving a request to talk from PoC Client A;
immediately notifying PoC Client B that permission to talk has been revoked;
receiving an acknowledgment from PoC Client B; and
granting PoC Client A permission to talk after receiving the acknowledgment from PoC Client B.

10. The method of claim 1, further comprising PoC Client B indicating to a user that the user has been pre-granted permission to talk.

11. The method of claim 1, further comprising PoC Client B indicating to a user that the user has the right to talk immediately after the user presses a push-to-talk (PTT) button.

12. An apparatus for providing rapid Talk Burst Control (TBC) for a Push To Talk over Cellular (PoC) Client engaged in a PoC communication, wherein PoC Client A is engaged in a PoC communication with PoC Client B, said apparatus comprising:
means for detecting the completion of a talk burst by PoC Client A; and
means for pre-granting PoC Client B permission to talk prior to receiving a request to talk from PoC Client B.

13. The apparatus of claim 12, wherein the means for pre-granting PoC Client B permission to talk includes means for sending a TBC protocol message to PoC Client B pre-granting PoC Client B the right to transmit media.

14. The apparatus of claim 12, wherein the means for pre-granting PoC Client B permission to talk includes a communication pattern model that predicts that PoC Client B is the predicted next talker.

15. The apparatus claim 14, wherein PoC Client A and PoC Client B are engaged in a person-to-person communication, and the communication pattern model predicts that talk bursts will alternate between PoC Client A and PoC Client B after each talk burst.

16. The apparatus of claim 12, wherein PoC Client A and PoC Client B are engaged in a group communication and PoC Client B owns the group, wherein the means for pre-granting PoC Client B permission to talk includes means for pre-granting PoC Client B permission to talk after each talk burst, regardless of who transmitted the talk burst.

17. The apparatus of claim 12, wherein PoC Client A and PoC Client B are engaged in a group communication and PoC Client B is a prioritized user, wherein the means for pre-granting PoC Client B permission to talk includes pre-granting PoC Client B permission to talk after each talk burst, regardless of who transmitted the talk burst.

18. The apparatus of claim 1, further comprising: a timer for measuring an allowed time period after PoC Client B is pre-granted permission to talk; and means for revoking the permission to talk if PoC Client B does not initiate a talk burst before the timer expires.

19. The apparatus of claim 12, further comprising:
means for receiving a request to talk from PoC Client A after pre-granting PoC Client B permission to talk;
means for immediately granting PoC Client A permission to talk; and
means for notifying PoC Client B that permission to talk has been revoked after granting PoC Client A permission to talk.

20. The apparatus of claim 12, further comprising:
means for receiving a request to talk from PoC Client A after pre-granting PoC Client B permission to talk;
means for immediately notifying PoC Client B that permission to talk has been revoked;
means for receiving an acknowledgment from PoC Client B; and
means for granting PoC Client A permission to talk after receiving the acknowledgment from PoC Client B.

21. The apparatus of claim 12, wherein the apparatus is implemented in a PoC Server that controls the communication.

22. A Push To Talk over Cellular (PoC) Client handset enabling a user to communicate with at least one other user through a PoC Server, said PoC Client handset comprising:
a push-to-talk (PTT) button for signaling to the PoC Server when the PTT button is pressed that a user requests permission to talk, and for signaling to the PoC Server when the PTT button is released that the user has finished talking; and
means for receiving from the PoC server an indication that the user has been pre-granted permission to talk prior to the user pressing the PTT button.

23. The PoC Client handset of claim 22, further comprising means responsive to the indication that the user has been pre-granted permission to talk, for transmitting media to the PoC Server without further signaling with the PoC Server.

24. The PoC Client handset of claim 22, further comprising means responsive to the indication that the user has been pre-granted permission to talk, for indicating to the user that the user has been pre-granted permission to talk.

25. The PoC Client handset of claim 22, further comprising means responsive to the indication that the user has been pre-granted permission to talk, for indicating to the user that the user has the right to talk immediately after the user presses the PTT button.
